(19) United States
(12) Patent Application Publication
(10) Pub. No.: US 2011/0024689 A1
(43) Pub. Date: Feb. 3, 2011

(54) METHOD FOR EXTENDING USEFUL LIFE OF INFLATED ARTICLES

(76) Inventor: Russell W. Koch, Hartville, OH (US)

Correspondence Address: ZOLLINGER & BURLESON LTD., PO BOX 2368, NORTH CANTON, OH, 44720, US

(21) Appl. No.: 12/903,850

(22) Filed: Oct. 13, 2010

Related U.S. Application Data
(62) Division of application No. 12/300,241, filed on Nov. 10, 2008.
(60) Provisional application No. 60/809,939, filed on May 31, 2006.

(51) Int. Cl. C23F 11/12; C23F 11/00; B23P 17/00

(52) U.S. Cl. 252/396; 252/387; 29/894.31

(57) ABSTRACT

A method for enhancing the useful life of inflated articles such as a pneumatic tire includes shipping a concentrate to the location of the tire, adding a diluent to the concentrate to form a composition, and introducing some or all of the composition into the inflation chamber of the tire. Concentrates and compositions, useful in this (and other) methods also are provided.

### CROSS-REFERENCE TO RELATED APPLICATIONS

This is a divisional application of U.S. application Ser. No. 12/300,241, presently pending, which is a national stage entry of international appl. no. PCT/US2007/011133, filed 9 May 2007, and claims the benefit of U.S. provisional patent appl. No. 60/809,939, filed 31 May 2006.

### BACKGROUND OF THE INVENTION

This invention relates generally to compositions and methods that enhance the useful life of inflated articles such as pneumatic tires.

Pneumatic tires generally fall into one of two classes, both of which can benefit from the compositions and methods described herein.

In tube-type assemblies, a casing confines an inner tube filled with air under pressure. Gradual loss of pressure can occur by passage of air through the inner tube due to natural (albeit slight) permeability of the rubber or because of small openings or holes in the tube. Use of this type of assembly in North America now is limited to certain specialty applications, although usage is more common in less-developed areas.

In tubeless assemblies, a lined casing is sealed to a metal wheel rim with the casing and rim defining a space filled with air under pressure. Loss of pressure can occur by air escaping through the liner and casing. Such air pressure loss can unnecessarily stress or fatigue the steel or fabric cords as well as cause undesirable flexing and heat buildup.

When servicing tubeless tires, mounting and demounting can cause damage to the bead area. The tubeless liner seal can be violated by the tire-changing apparatus and, because this often occurs during the final mounting of the tire on the wheel rim, it is not readily detectable. This type of damage can cause air to leak into the tire cord structure which, if not properly monitored and addressed by the user, can in some circumstances result in serious air pressure loss from the air chamber and/or oxidation of portions of the tire structure.

Air leaking outwardly through a tubeless tire structure, if undetected and not addressed by the user, can result in damage up to, in some cases, ply separation. Such separation can occur between any of the plies, although it occurs most frequently in the top ply area (particularly in recapped tires).

Maintaining air pressure in the inflation chamber (i.e., a tube or the space defined by rim and casing) to a large extent determines the load range of a tire. Loss of this pressure can result in under-inflation and overloading of the tire. Under-inflation by as little as 5% of normal pressure can cause heat to build up, particularly in tires having a large number of plies. Tires that do not maintain air pressure require frequent infusions of air, each of which results in the introduction of fresh oxygen into the inflation chamber which, over time, can result in oxidation and other undesirable effects, the magnitude of which can be exacerbated by the increased heat inherent in operation of an under-inflated tire (unless a more expensive gas such as nitrogen is employed).

All of the foregoing is of particular concern in industries that employ heavy equipment which employ very large tires. Examples of such equipment are mining and construction trucks, agricultural tractors and combines, and the like. Tires used on such vehicles often have diameters of at least ˜2 m and operate at high temperatures.

Various compositions have been proposed for inhibiting air pressure losses in pneumatic tire assemblies. However, some of these have caused or resulted in new sets of problems such as, for example, unbalancing of the mounted tire assembly, swelling or softening of the rubber, negatively impacting the cord structure, corroding the metal rim of the wheel assembly, etc.

Tire Life™ preservative (Fuller Brothers, Inc.; Clackamas, Oreg.) is used widely in heavy equipment tires for inhibiting air leakage and metal corrosion. Its composition, believed to be described generally in U.S. Pat. No. 3,881,943, includes sodium benzoate as a buffering component; sodium nitrite and, optionally, sodium chromate as corrosion inhibitors; and ethylene glycol as a freezing point adjuster. Despite a relatively high price (relative to the cost of its ingredients), it is used widely because it is considered to achieve its intended purposes without the types of deleterious side effects mentioned above.

This material is sold as a ready-to-use, premixed aqueous solution. Thus, the user purchases a great deal (often in excess of ˜90%) water and then pays a tremendous shipping surcharge to have that aqueous solution delivered to where it is to be used. Additionally, a not insignificant amount of energy could be saved if the active ingredients of the preservative composition could be delivered separate from the water.

### SUMMARY OF THE INVENTION

A need for preservative compositions that are more effective and/or easier to use than those presently available remains. Also, providing the types of beneficial effects achieved through the use of such compositions while, at the same time, ameliorating one or more of the issues that can accompany their use (e.g., shipping costs) remains desirable.

The appended claims provide the most succinct descriptions of the inventive contributions, which include a concentrate and method for using such a concentrate to provide a preservative composition. The concentrate can be used to provide a composition that can inhibit degradation of the inner liner of inflated articles such as pneumatic tires by wetting its surface. The concentrate can include a high level of active ingredients, i.e., include a moderate amount of, or even very little, added water. The concentrate can be diluted with water or other diluent to provide a pre-determined volume of preservative composition. This dilution can be performed at the site of usage, a process which entails substantial cost savings (through reduced shipping charges) for the user.

In one aspect is provided a method for providing a preservative composition for use in a pneumatic tire. The method includes shipping a concentrate to a site where a tire is to be mounted, adding a diluent to the concentrate to form the composition, and introducing some or all of the composition into the inflation chamber of the tire. The method optionally can include the additional step of mounting the tire onto a wheel assembly.

In another aspect is provided a composition of at least one salt of a polyacid, an inorganic corrosion inhibitor and, optionally, a freezing/boiling point adjusting agent such as a glycol. The salts of one or more polyacids can constitute at least ˜50% (by wt.), at least ˜60% (by wt.), at least ˜70% (by wt.), at least ˜75% (by wt.), at least ˜80% (by wt.), at least ˜85% (by wt.), at least ˜90% (by wt.), at least ˜95% (by wt.), or even essentially all of the buffer precursors used in the composition. Mono-basic organic acids also can be present in the composition.

In certain embodiments, the composition can include a minimal amount of diluent (e.g., added water). In these or other embodiments, the composition can include at least ˜25% (by wt.), at least ˜33% (by wt.), at least ˜40% (by wt.), at least ˜50% (by wt.), at least ˜60% (by wt.), at least ˜70% (by wt.), at least ˜75% (by wt.), at least ˜80% (by wt.), or at least ˜90% (by wt.) active ingredients.

To assist in understanding the following description of embodiments of the foregoing method and compositions, certain definitions are provided immediately below, and these are intended to apply throughout unless the surrounding text explicitly indicates a contrary intention:

“buffer” means a compound or mixture of compounds having an ability to maintain the p_{c}H of a solution to which it is added within relatively narrow limits;

“buffer system” means a buffer composed of two or more compounds;

“buffer precursor” means a compound that, when subjected to acidic or basic conditions, forms the additional component necessary for the two materials to form a buffer system (e.g., a salt of a weak acid, when introduced to an acidic environment, can form enough of its corresponding weak acid that the two compounds can act as a buffer system);

“polyacid” means a compound having at least two carboxyl groups and specifically includes dicarboxylic acids, tricarboxylic acids, etc.;

“composition” means solution or mixture;

“preservative,” as an adjective, means capable of inhibiting degradation of rubber surfaces, inhibiting rim corrosion (e.g., rust), and/or reducing operating temperature; and

“concentrate” means a mixture (dry or wet) or solution containing active ingredients and, optionally but typically, inactive ingredients and being capable of being added to a relatively large amount of diluent so as to form a preservative composition of reduced, but effective, concentration.

### DETAILED DESCRIPTION OF ILLUSTRATIVE EMBODIMENTS

This description focuses on the use of a preservative composition to inhibit degradation of inner liners which can cause pressure loss in a pneumatic tire. Although this is a particularly desirable utility, the composition also can be effective when used in other types of inflated objects (e.g., basketballs) or even certain metallic items.

Prior to a preservative composition being used, it must be provided or delivered. Unlike prior methods for providing preservative compositions, the present method allows an end user to make the composition at the site where it is to be used. This on-site manufacture means that much less diluent, typically water, needs to be shipped from the point of initial assembly to the use site, resulting in significant energy and cost savings.

Where a preservative composition is to be used in a tire assembly, the concentrate from which the composition is prepared will include at least one buffer precursor, generally a salt of an acid (e.g., metal carboxylate), and at least one corrosion inhibitor. Unless the composition is to be used only in very temperate climates, a freezing/boiling point modifier also can be included. Adjuvants such as surfactants and/or colorants can be provided in relatively minor amounts. Each of these concentrate components is discussed separately below.

A variety of salts of acids can be employed as buffer precursors in the concentrate. Exemplary acids include monobasic acids such as, e.g., formic acid, acetic acid, propionoic acid, lactic acid, benzoic acid, and the like; dibasic acids such as, e.g., succinic acid, glutaric acid, adipic acid, tartaric acid, and the like; tribasic acids such as, e.g., citric acid, 2-methylpropane-1,2,3-tricarboxylic acid, benzenetricarboxylic acid, and the like; tetrabasic acids such as prehnitic acid, pyromellitic acid, and the like; and even higher functional compounds. In the foregoing exemplary acids, one or more halogen atoms can replace one or more hydrogen atoms; for example, if acetic acid is useful, one or more of trichloroacetic acid, 2,2-dichloroacetic acid, and chloroacetic acid also might be useful. Acids that include groups that enhance solubility in water or alcohols (e.g., hydroxyl groups), examples of which include tartaric acid, citric acid, and citramaleic acid, can be preferred in some circumstances.

Polyacids can provide 2, 3, 4, etc., equivalents of buffering capacity per mole of compound. Thus, where maximum weight reduction (and the concomitant energy and cost savings are desired), use of one or more polyacids as buffer precursors can be preferable. Particularly preferred are salts of polyacids with three or more carboxyl groups, and most preferred are those that are highly soluble in water; examples include citric acid, tartaric acid, and benzenetricarboxylic acid.

The identity of the countercation portion of the salt is not particularly critical. Common examples include ammonium ions and alkali metals. Where a polyacid is used, all or fewer than all of the carboxyl hydrogens can be replaced with cationic atoms or groups, which can be the same or different. Thus, disodium and trisodium citrate both constitute useful buffer precursors. However, because trisodium citrate has three available basic sites, it has a theoretical buffering capacity up to 50% greater than that of disodium citrate with two such sites.

A primary purpose of the buffer precursor is to react with any acids that might be present or form on the interior surface of the tire casing (or other components) and/or the wheel rim. Acids are themselves corrosive and can initiate or catalyze other undesirable reactions such as hydrolysis.

The concentrate also includes at least one agent designed to minimize or inhibit corrosion of the metal wheel rim. Common examples include various alkali metal nitrites (e.g., NaNO₂), chromates (e.g., K₂CrO₄), nitrates (e.g., NaNO₃), borates (e.g., Na₂B₄O₇.10H₂O), phosphates (e.g., K₂HPO₄ and Na₂HPO₄.7H₂O), molybdates (e.g., Na₂MoO₄), triazoles (e.g., sodium tolyltriazole and 1,2,3-benzotriazole), amine salts of polycarboxylic acids and boron-containing variants as described in U.S. Pat. No. 4,533,481 (e.g., Addco™ CP inhibitors available from Lubrizol Corp. in Cleveland, Ohio), polycarboxylic acid salts of (di)alkanolamines such as ethanolamine, salts of polyacrylic acid, EDTA (tetrasodium salt), and functionalized and/or emulsified oils (e.g., sulfonated castor oil); the chromates are environmentally disfavored in some areas, and the long-term solubility or dispersibility of oils might present some stability issues. The cation of this material can be the same as or different than the one used with the buffer precursor. Those materials that provide slightly to moderately basic solutions when dissolved in water (e.g., salts of weak acids) might provide some long term benefits relative to other types of corrosion inhibitors; for example, in certain embodiments, the salt of a weak acid such as sodium borate might be preferable to the salt of a strong acid, e.g., sodium nitrate.

Although not required in all cases, a freezing/boiling point adjusting agent can be included in the concentrate. These typically are materials that are highly soluble in the intended diluent and that have relatively high boiling points (generally at least about 125° C., preferably at least about 150° C., and more preferably at least about 175° C. at atmospheric pressure) and/or vapor pressures. Especially where water is the intended diluent, exemplary materials include polyols such as ethylene glycol and 1,2-propanediol (i.e., propylene glycol) and water soluble, relatively low molecular weight polymers of such polyols, i.e., polypropylene glycol, polyethylene glycol, and the like.

The foregoing constitute the primary active ingredients of the concentrate and solution made therefrom. The concentrate generally includes at least about 25% (by wt.) active ingredients, although this amount often is much greater. In some embodiments, the concentrate includes at least about 33% (by wt.), at least about 40% (by wt.), or at least about 50% (by wt.) active ingredients. In other embodiments, the concentrate can include at least about 60% (by wt.), at least about 70% (by wt.), at least about 75% (by wt.), or at least about 80% (by wt.) active ingredients. In certain embodiments, the concentrate can include at least about 90% (by wt.) or at least about 95% (by wt.) active ingredients. The concentrate can include water, although typically not in amounts that will dissolve the active (and, if present, inactive) ingredients; even where sufficient water is present to dissolve all active and inactive ingredients, additional water must be added to provide the preservative composition.

The actual amounts of the primary active ingredients in a particular concentrate depends to a very large extent on the size of the container in which dilution is to occur. For example, in countries and regions employing English units, some of the most commonly available containers include 55-gallon (˜0.2 kL) drums and 400-gallon (˜1.5 kL) shipping containers; in countries and regions employing metric units, some of the most commonly available containers include 0.2 and 0.4 kL drums and 1.0 and 1.5 kL containers. Amounts of various components are discussed in more detail below.

In addition to the foregoing materials, various adjuvants can be included in the concentrate. Materials that commonly might be incorporated include surfactants (which can help to wet the surfaces of the rim and the liner of the tire), particularly those that are designed to be low-foaming, and colorants or dyes. Materials not as commonly used but which can be included if needed or desired include biocides and preservatives. All such adjuvants preferably are used in relatively minor amounts, e.g., generally less than ˜2% (by wt.), more commonly less than ˜1% (by wt.), and often less than about 0.5% (by wt.) of the total concentrate.

Following are three exemplary concentrates intended for dilution in a standard 55-gallon (˜0.2 kL) drum, although scaling up or down from these numbers based on the volume of the available or desired dilution vessel(s) can be accomplished by the ordinarily skilled artisan. In each case, the solid components (i.e., salts of organic acids, corrosion inhibitors and colorants) were mixed thoroughly in a ribbon blender; the liquid components such as glycols and surfactants were mixed separately and either poured slowly over or sprayed on the mixing solids. (If desired, although certainly not required, concentrates such as those that follow can be diluted with, e.g., water, so as to fill a shipping container of a desired size or volume (e.g., 5-gallon pail). Prior to use, such a semi-diluted concentrate preferably is mixed or shaken so as to ensure that all active ingredients are transferred into the larger mixing container.)

TABLE 1
First exemplary concentrate

| Material | Amount (kg) |
|---|---|
| sodium benzoate | 11.350 |
| sodium nitrite | 1.566 |
| propylene glycol | 1.497 |
| Tergitol ™ 15-S-12 surfactant | 0.022 |
| Triton ™ DF-16 surfactant | 0.020 |
| Yellow 17 dye | 0.036 |
| Blue 3 dye | 0.004 |
| TOTAL | 14.495 |

TABLE 2
Second exemplary concentrate

| Material | Amount (kg) |
|---|---|
| sodium benzoate | 5.675 |
| sodium citrate | 3.859 |
| sodium nitrite | 1.566 |
| propylene glycol | 1.498 |
| Tergitol ™ 15-S-12 surfactant | 0.022 |
| Triton ™ DF-16 surfactant | 0.020 |
| Yellow 17 dye | 0.036 |
| Blue 3 dye | 0.004 |
| TOTAL | 12.680 |

TABLE 3
Third exemplary concentrate

| Material | Amount (kg) |
|---|---|
| sodium citrate | 7.718 |
| sodium nitrite | 1.566 |
| propylene glycol | 1.498 |
| Tergitol ™ 15-S-12 surfactant | 0.022 |
| Triton ™ DF-16 surfactant | 0.020 |
| Yellow 17 dye | 0.036 |
| Blue 3 dye | 0.004 |
| TOTAL | 10.864 |

In comparing the concentrates in Tables 1 and 2, one can see that the latter weighs nearly 2 kg less than the former but is predicted to have significantly more buffering capacity. Similarly, the concentrate from Table 3 weighs 25% less than that from Table 1 but is predicted to have more buffering capacity (i.e., ˜90 equivalents of acid versus ˜80). However, roughly estimating the weight of the contents of a full 55-gallon (˜0.2 kL) drum as 205 kg (˜450 lbs.), any of these concentrates can result in at least a 95% reduction in weight of material being shipped; this can significantly reduce the amount of energy required for shipping.

In the present method, dilution of a concentrate generally is intended to occur at a point where a preservative composition is to be used. For example, the exemplary concentrates set forth in the foregoing tables, which can be transported in 5-gallon (˜19 L) pails, are intended for dilution in a 55-gallon (˜0.2 kL) drum. When such a concentrate arrives at a particular job site, it can be added to that size drum and diluted with, e.g., water. Unless on-site water is particularly polluted or acidic, it can be added to the concentrate as-is. In certain circumstances—for example, if the water is unusually acidic—pretreatment can be desirable.

The buffer precursors typically constitute ˜3-6% or ˜4-5% (by wt.) of the preservative composition. Such compositions generally include at least about 2% (by wt.), typically at least about 3% (by wt.), and even more typically at least about 4% (by wt.) of buffer precursor(s); up to about 25% (by wt.) can be utilized in special circumstances although typically no more than about 15% (by wt.), and more typically no more than about 10% (by wt.), is necessary.

Corrosion inhibitor(s) and boiling point/freezing point adjusting agent(s) each typically constitute ˜0.5-1.5% (by wt.) of the preservative composition. Such compositions generally include at least about 0.25% (by wt.), typically at least about 0.33% (by wt.), and even more typically at least about 0.4% (by wt.) of these components; up to ˜50% (by wt.) of each can be utilized in special circumstances (such as a large amount of freezing point adjuster(s) for tires used in extremely cold conditions, e.g., ambient temperatures on the order of −50° C.) although typically no more than about 15% (by wt.), more typically no more than about 5% (by wt.), and most often no more than about 2.5% is considered beneficial.

The amount of preservative composition employed by an end user can vary significantly depending on the size of tire(s) to be protected. The amount to be used is that which effectively preserves (i.e., extends the useful life) of the tire by, for example, inhibiting loss of air pressure; generally, this constitutes an amount that maintains the integrity of the liner seal while allowing for some loss during typical maintenance procedures such as replacing a valve core, reseating a rim or repairing a puncture. If operating temperature reduction is desired, the amount of preservative composition can be increased somewhat, although such efforts face a natural upper limit reached when sufficient water vaporizes inside the tire so as to set up equilibrium.

The types of preservative compositions just described have relatively low viscosities, substantially similar to water. This enables them to be introduced in a variety of ways including, most commonly, being poured into a tire casing assembly. Low viscosities also facilitate uniform distribution of the compositions over the inner surface of the tires and wheels.

Having described the method of the present invention, the remainder of the description focuses on certain preferred concentrates and preservative compositions made therewith.

Concentrates include at least one buffer precursor and a corrosion inhibitor. In certain preferred embodiments, specific types of these two components are employed.

A significant portion of the buffer precursors used in the composition can be salt(s) of polyacid(s). Specifically, such salts preferably constitute at least 50%, at least 60%, at least 70%, at least 75%, at least 80%, at least 85%, at least 90%, at least 95%, or even essentially all of buffer precursors employed in these types of preferred concentrates. (Each of the foregoing are weight percentages, based on the total weight of buffer precursors.)

Salts of polyacids can provide 2, 3, 4, etc., equivalents of buffering capacity per mole of compound and thus, can provide additional weight reduction. Trisodium and tripotassium citrate are examples of particularly preferred buffer precursors.

In certain embodiments, a concentrate employing a buffer system of two or more of such salts can be used.

With respect to corrosion inhibiting agents, alkali metal nitrites such as sodium nitrite are preferred because, among other things, they are environmentally benign and highly soluble in water.

Some concentrates include only the foregoing and, optionally, freezing/boiling point adjusting agent(s) of the types described previously as active ingredients. Such active ingredients can constitute at least about 25%, at least about 33%, at least about 40%, at least about 50%, at least about 60%, at least about 70%, at least about 75%, at least about 80%, at least about 90%, or at least about 95% of the total weight of the concentrate. In certain embodiments, the concentrate can include only active ingredients, although adjuvants of the type described previously often are included.

As described previously, the volume of concentrate can vary widely depending on the volume of the container in which it is to be diluted. Thus, molar ratios are utilized here to provide relative amounts of the foregoing active ingredients. Exemplary concentrates (and preservative compositions, assuming dilution with pure diluent) can employ molar ratios of salt(s) of polyacid(s) to corrosion inhibiting agent(s) on the order of from about 1:1 to about 10:1, generally about 3:2 to about 5:1, preferably from about 2:1 to about 7:2. The amount of freezing/boiling point adjusting agent(s) depends on the area of intended use but, in general, is on the order of from about 1:1 to about 4:1 relative to the (molar) amount of corrosion inhibiting agent(s).

Preservative compositions can be made from such concentrates by diluting as described previously.

While various embodiments of the present invention have been provided, they are presented by way of example and not limitation. The following claims and their equivalents define the breadth and scope of the inventive methods and compositions, and the same are not to be limited by or to any of the foregoing exemplary embodiments.

I claim:

1. A method for providing a preservative composition for use in a pneumatic tire to be mounted on a wheel assembly, said method comprising:
a) at a site where said tire is to be mounted, adding a diluent to a concentrate that comprises at least one buffer precursor and at least one corrosion inhibitor, and
b) introducing some or all of said composition into the inflation chamber of said tire.

2. The method of claim 1 wherein said at least one buffer precursor comprises a salt of a polyacid.

3. The method of claim 2 wherein said salt of a polyacid comprises essentially all of said at least one buffer precursor.

4. The method of claim 2 wherein said at least one buffer precursor comprises salts of more than one polyacid.

5. The method of claim 1 wherein said at least one corrosion inhibitor comprises only inorganic materials.

6. The method of claim 5 wherein said at least one inorganic corrosion inhibiting material is the salt of a weak acid.

7. The method of claim 1 wherein said concentrate comprises at least about 50% by weight active ingredients.

8. The method of claim 1 wherein said concentrate further comprises a glycol.

9. The method of claim 1 further comprising mounting said tire onto a wheel assembly.

10. The method of claim 1 wherein said buffer precursor comprises at least 50% by weight of a salt of at least one polyacid.

11. The method of claim 10 wherein said buffer precursor comprises at least 75% by weight of a salt of at least one polyacid.

12. The method of claim 1 wherein said at least one corrosion inhibitor consists essentially of sodium nitrite.

13. The method of claim 1 wherein said at least one corrosion inhibitor consists essentially of sodium citrate.

14. The method of claim 1 wherein said buffer precursor is trisodium citrate and said corrosion inhibitor is sodium nitrite, wherein the molar ratio of trisodium citrate to sodium nitrite being from about 2:1 to about 7:2.

15. The method of claim 14 wherein said buffer precursor further comprises a glycol.

16. The method of claim 1 wherein said buffer precursor comprises salts of more than one polyacid.

17. The method of claim 1 wherein said concentrate further comprises at least one surfactant.

18. The method of claim 1 wherein said diluent is water.

19. The method of claim 18 wherein said water is available at said site and is used with pretreatment.

20. The method of claim 1 wherein said concentrate is provided in a 5-gallon container.
